(19) United States
(12) Patent Application Publication
(10) Pub. No.: US 2014/0191914 A1
(43) Pub. Date: Jul. 10, 2014

(54) MULTI-CHANNEL ANTENNA DEVICE

(71) Applicant: Electronics and Telecommunications Research Institute, Daejeon (KR)

(72) Inventors: JeongHo JU, Daejeon (KR); Soon Young EOM, Daejeon (KR); Joung Myoun KIM, Daejeon (KR); Myung Sun SONG, Daejeon (KR); Jae Ick CHOI, Daejeon (KR)

(73) Assignee: Electronics and Telecommunications Research Institute, Daejeon (KR)

(21) Appl. No.: 14/084,689

(22) Filed: Nov. 20, 2013

(30) Foreign Application Priority Data
Jan. 7, 2013 (KR) 10-2013-0001551
Aug. 9, 2013 (KR) 10-2013-0094862

(51) Int. Cl. H01Q 21/30

(52) U.S. Cl. CPC H01Q 21/30
USPC 343/727; 343/725; 343/729

(57) ABSTRACT

A device includes a feeding circuitry, a basic mode radiator for forming a basic mode main beam pattern having one or two orthogonal polarizations based on first two orthogonal inputs received from the feeding circuitry, and a higher-order mode radiator for forming a higher-order mode conical beam pattern having one or two orthogonal polarizations based on second two orthogonal inputs received from the feeding circuitry.

### RELATED APPLICATIONS(S)

This application claims the benefit of Korean Patent Application No. 10-2013-0001551, filed on Jan. 7, 2013 and Korean Patent Application No. 10-2013-0094862, filed on Aug. 9, 2013, which are hereby incorporated by references as if fully set forth herein.

### Field of the Invention

The present invention relates to a multi-channel antenna device, and more particularly, to a multi-channel antenna device using the radiation pattern and orthogonal polarization diversity of an antenna.

### BACKGROUND OF THE INVENTION

In general, in wireless terrestrial/satellite communication systems, data is wirelessly transmitted and received through an antenna using a specific frequency. Here, an important element for transmitting and receiving signals in a wireless terrestrial/satellite communication system includes an antenna disposed at the end of the wireless terrestrial/satellite communication system.

The antenna of the wireless terrestrial/satellite communication system needs to be configured to transmit and receive electromagnetic waves efficiently. To this end, active research and development are being carried on the antenna.

There are various types of antennas. Antennas that are commonly used in a high frequency include a dipole antenna, a monopole antenna, a patch antenna, a horn antenna, a parabolic antenna, a helical antenna, and a slot antenna. The antennas are applied and used in various forms depending on the communication distance and coverage.

Resources essential for a wireless terrestrial/satellite communication system involve the frequency, polarizations, space, and directions. At the present time and in the future, frequency resources, that is, the most important resources for wireless communication, become exhausted due to an increase in the type of wireless communication service, and Multiple Input Multiple Output (MIMO) communication technology is essentially necessary due to broadband service. An object of this MIMO communication technology is to increase a communication capacity by performing independent multi-channel transmission using multiple channels.

Most of existing wireless satellite communication/mobile communication terminals or relays/base station antennas for MIMO communication, however, use predetermined and fixed polarizations and antenna beam patterns. An antenna structure having this fixed polarization and beam pattern is not suitable for a MIMO antenna structure for future high-speed data transmission.

In the future, new wireless resources, such as polarizations, space, and directions (i.e., antenna beam patterns), will need to be flexibly applied and utilized owing to the saturation (or exhaustion) of frequency resources for wireless communication. Accordingly, in the next-generation MIMO antenna structure, the polarization and beam pattern of an antenna as well as a high isolation characteristic between antennas should be formed to be suitable for wireless environments and system requirements.

### SUMMARY OF THE INVENTION

In view of the above, the present invention provides two independent radiation beam pattern characteristics or two orthogonal polarization characteristics at the same time. That is, the present invention provides an antenna device having two orthogonal polarizations or two beam patterns (i.e., a forward beam pattern and a conical beam pattern) performance when four independent input signals are applied to an antenna.

In accordance with an aspect of the exemplary embodiment of the present invention, there is provided a multi-channel antenna device, which includes a feeding circuitry, a basic mode radiator for forming a basic mode main beam pattern having one or two orthogonal polarizations based on first two orthogonal inputs received from the feeding circuitry, and a higher-order mode radiator for forming a higher-order mode conical beam pattern having one or two orthogonal polarizations based on second two orthogonal inputs received from the feeding circuitry.

In the exemplary embodiment, the basic mode radiator and the higher-order mode radiator may include has a complex stack type radiator structure in which the basic mode radiator is formed over the higher-order mode radiator with a dielectric interposed between the basic mode radiator and the higher-order mode radiator.

In the exemplary embodiment, the dielectric may include a plastic element.

In the exemplary embodiment, the basic mode radiator may include a printed-cross dipole antenna.

In the exemplary embodiment, the basic mode radiator may include a stereographic dipole antenna.

In the exemplary embodiment, the basic mode radiator may include a single or stack microstrip antenna.

In the exemplary embodiment, the higher-order mode radiator may include a single or stack annular-ring antenna.

In the exemplary embodiment, the higher-order mode radiator may include a single or stack circular antenna.

In the exemplary embodiment, a portion of the higher-order mode radiator may be used as a ground surface of the basic mode radiator.

In the exemplary embodiment, the portion may include a stack parasitic element of the higher-order mode radiator.

In the exemplary embodiment, a short region may be placed in a central part of the stack parasitic element.

In the exemplary embodiment, the ground surface may include a conductor wall formed in a specific height along an outer circumferential surface of the ground surface.

In the exemplary embodiment, the conductor wall may provides a backward radiation suppression function.

In the exemplary embodiment, a portion of the higher-order mode radiator may be used as a reflector structure of the basic mode radiator.

In the exemplary embodiment, the feeding circuitry may performs a 90-degree phase delay function and an input impedance matching function when a circular polarization is necessary.

### BRIEF DESCRIPTION OF THE DRAWINGS

The above and other objects and features of the present invention will become apparent from the following description of embodiments given in conjunction with the accompanying drawings, in which:

FIG. 1 is a block diagram of a MIMO antenna having a complex radiator with basic and higher-order modes in accordance with the present invention.

FIG. 2 shows a MIMO antenna structure having a complex radiator with basic and higher-order modes in accordance with the present invention.

FIG. 3 is a conceptual diagram illustrating an excitation method for forming a higher-order mode.

FIG. 4 shows the shape of a 4-channel MIMO antenna having a complex radiator in accordance with an embodiment of the present invention.

FIG. 5 shows the structure of a dipole antenna that forms two channels.

FIGS. 6a and 6b show the structure of an annular-ring antenna that forms two channels.

FIGS. 7a to 7d are graphs showing the reflection losses and isolation characteristics of four MIMO antennas.

FIGS. 8a to 8d are graphs and beam patterns showing the radiation patterns of the four MIMO antennas.

### DETAILED DESCRIPTION OF THE EMBODIMENTS

Hereinafter, embodiments of the present invention will be described in detail with reference to the accompanying drawings so that they can be readily implemented by those skilled in the art.

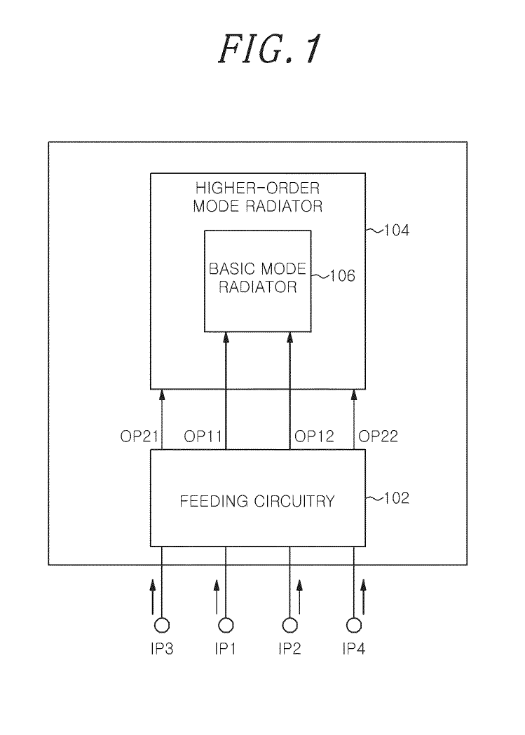

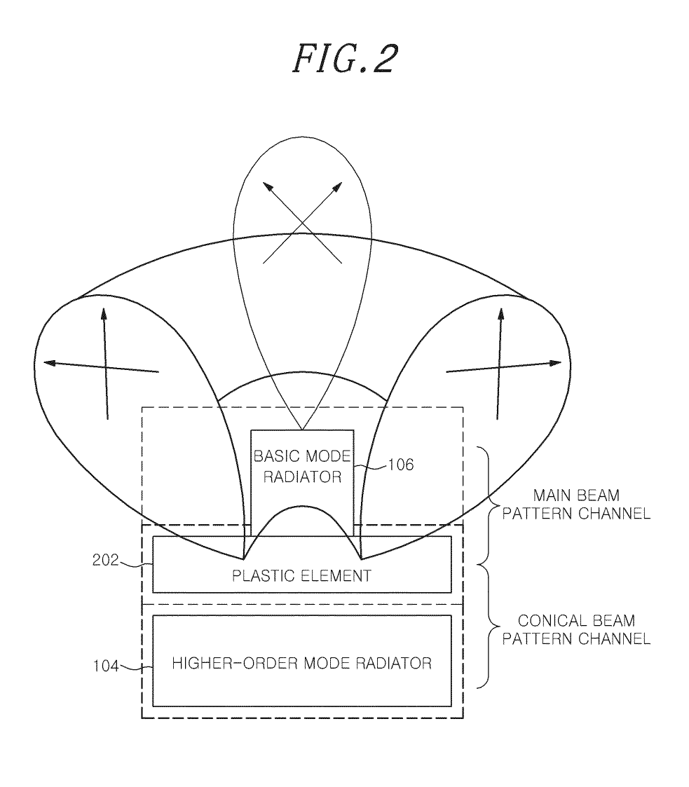

FIG. 1 is a block diagram of a MIMO antenna having a complex radiator with basic and higher-order modes in accordance with the present invention, and FIG. 2 shows a MIMO antenna structure having a complex radiator with basic and higher-order modes in accordance with the present invention.

In the present invention, the MIMO antenna structure having a complex radiator with basic and higher-order modes, such as that shown in FIGS. 1 and 2, is used so that input terminals can form different channels while not influencing other input terminals.

Referring to FIG. 1, input terminals IP1 and IP2 are orthogonally inputted to a basic mode radiator 106 through a feeding circuitry 102, and input terminals IP3 and IP4 are orthogonally inputted to a higher-order mode radiator 104 through the feeding circuitry 102.

Here, the feeding circuitry 102 is not used when a linear polarization is necessary, but is used to implement a 90-degree phase delay circuit (or function) and perform an input impedance matching function when a circular polarization is necessary. The basic mode radiator 106 forms a main beam pattern in a forward direction, and the higher-order mode radiator 104 forms a conical beam pattern in the forward direction. That is, the basic mode radiator 106 can form a basic mode main beam pattern having one or two orthogonal polarizations based on two orthogonal inputs OP11 and OP12 that are received from the feeding circuitry 102. The higher-order mode radiator 104 can form a higher-order mode conical beam pattern having one or two orthogonal polarizations based on two orthogonal inputs OP21 and OP22 that are received from the feeding circuitry 102.

That is, for the purpose of the matching and band extension of a MIMO antenna, a complex stack type radiator structure in which the basic mode radiator 106 is stacked over the higher-order mode radiator 104 with a plastic element 202, functioning as a dialectric, interposed therebetween as shown in FIG. 2, for example, can be used. The central part of a portion (i.e., a stack parasitic element) of the higher-order mode radiator 104 is a short region. Thus, the central part of a portion of the higher-order mode radiator 104 can be shorted through a connection with a ground surface at the bottom of the higher-order mode radiator 104 in order to be used as the ground surface of the basic mode radiator 106. The complex stack type radiator structure needs to be taken care of when being designed because the unique electrical characteristics of the radiators can influence each other. Here, a portion (e.g., a stack parasitic element) of the higher-order mode radiator 104 may be used as the reflector structure of the basic mode radiator 106.

Referring back to FIG. 2, a main beam pattern channel having two orthogonal linear polarizations or circular polarizations can be formed through the basic mode radiator 106, and a conical beam pattern channel having two orthogonal linear polarizations or circular polarizations can be formed through the higher-order mode radiator 104. An isolation characteristic of 20 dBc can be obtained between the input terminals.

The basic mode radiator 106 can be any one of, for example, a printed-cross dipole antenna, a stereographic dipole antenna, and a single or stack microstrip antenna having a patch structure. The higher-order mode radiator 104 can be any one of, for example, a single or stack annular-ring antenna having a patch structure and a single or stack circular antenna having a patch structure. Here, when taking the size, directional characteristic, and operating bandwidth characteristic of all the antennas into consideration, a stack annular-ring microstrip antenna (ARMSA) may be most suitable for the higher-order mode radiator structure on the lower side and a printed-cross dipole antenna or a stack microstrip antenna may be most suitable for the basic mode radiator structure on the upper side.

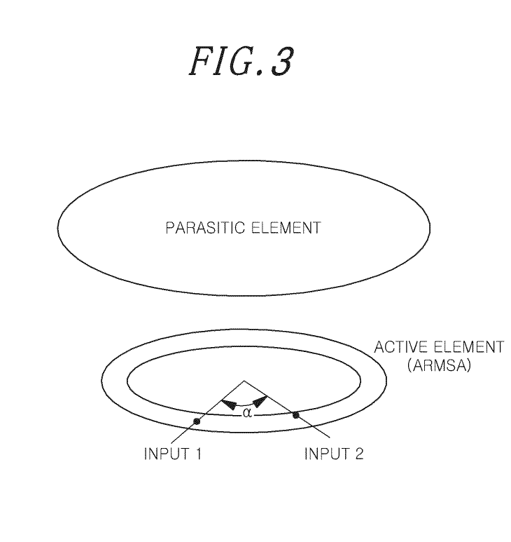

FIG. 3 is a conceptual diagram illustrating an excitation method for forming a higher-order mode. A first-order basic mode TM11 can be formed when an angle a between two input terminals 1 and 2 is 90 degrees, a second-order higher-order mode TM21 can be formed when the angle a between the two input terminals 1 and 2 is 45 degrees or 135 degrees, a third-order higher-order mode TM31 can be formed when the angle a between the two input terminals 1 and 2 is 30 degrees or 90 degrees, and a fourth-order higher-order mode TM41 can be formed when the angle a between the two input terminals 1 and 2 is 22.5 degrees or 67.5 degrees. As the order of a higher-order mode increases, a maximum (or peak) beam direction of a conical beam deviates in the forward direction from 35 degrees to 70 degrees.

Next, a dipole antenna, that is, the basic mode radiator, is designed with an initial value of 0.25 λg in length in the center frequency and then optimized through simulations.

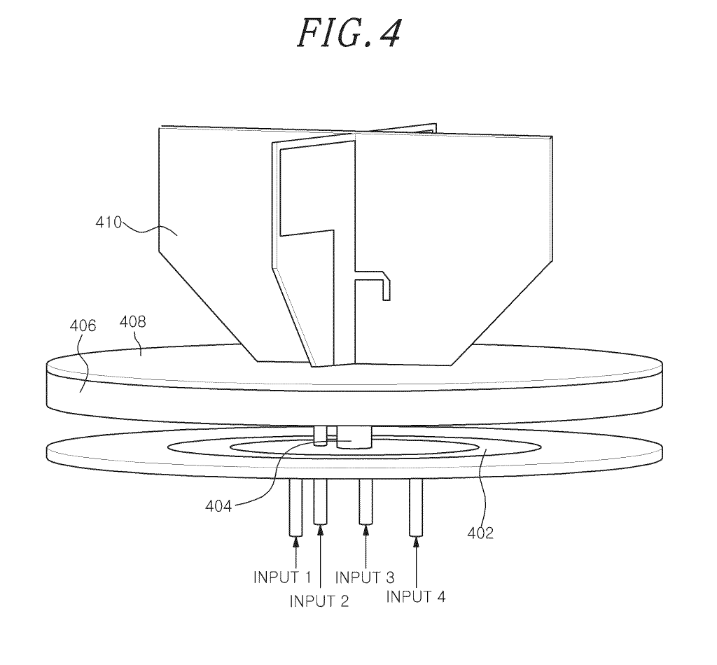

FIG. 4 shows the shape of a 4-channel MIMO antenna having a complex radiator in accordance with an embodiment of the present invention.

Referring to FIG. 4, the 4-channel MIMO antenna can include a higher-order mode radiator 402 configured to have an annular-ring microstrip antenna applied thereto, a short pole 404, a dielectric 406 configured to have a ground surface 408, and a basic mode radiator 410 configured to have a monopole antenna applied thereto. The whole size of the 4-channel MIMO antenna is about 0.75 to 0.85 λo in diameter and about 0.2 to 0.5 λo in height. If a stereographic-crossed dipole radiation structure, that is, the basic mode radiator, the whole size of the 4-channel MIMO antenna is about 0.5 λo. A conductor wall having a specific height may be formed along the outer circumferential surface of the ground surface 408. The conductor wall can reduce a size and provide a backward radiation suppression function.

The 4-channel MIMO antenna has an antenna gain of 7 to 8 dBi in the case of a main beam and has a middle gain of about 3 dBi in the case of a conical beam. The directivity/gain characteristics can be used in a MIMO antenna for a middle and short-distance wireless Access Point (AP).

Signals inputted to input terminals 1 and 2 are independently transferred to monopole antennas, that is, antenna devices, through feeding points. Here, the current distributions of signals excited by the respective antenna device have the same amplitude.

The patterns of the signals that have been received through the input terminals 1 and 2 and radiated by the monopole antennas under the above conditions have −45-degree and +45-degree linear polarizations (or +45-degrees and −45-degree linear polarizations), thus forming pencil beam shapes that are radiated forwardly. The orthogonal polarization characteristics can improve an isolation characteristic between the two monopole antennas and form two independent channels.

In a similar way, signals applied to input terminals 3 and 4 are transferred to annular-ring antennas through feeding points that are spaced apart from each other 90 degrees. Here, the current distributions of signals excited by the annular-ring antenna device have the same amplitude.

The patterns of the signals that have been received through the input terminals 3 and 4 and radiated by the annular-ring antennas under the above conditions have −45-degree and +45-degree linear polarizations (or +45-degrees and −45-degree linear polarizations) and form conical beam shapes having non-directional characteristics in an azimuth direction when the signals become null forwardly. The orthogonal polarization characteristics can improve an isolation characteristic between the two annular-ring antennas and form two independent channels.

For example, an antenna structure, such as that shown in FIG. 4, can be used in a 4-channel MIMO system.

The performance of an antenna proposed by the present invention, suitability in which the antenna of the present invention can be used in a 4-channel MIMO system, and the characteristics of an MIMO antenna are described below regarding a radiation pattern and a reflection loss of the antenna and isolation between the antennas in connection with the aforementioned embodiment of the antennas using four independent input signals.

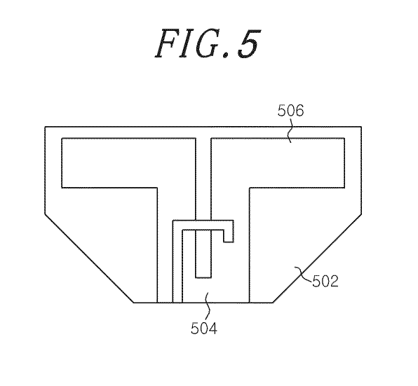

FIG. 5 shows the structure of a dipole antenna that forms two channels. The dipole antenna has been illustrated as forming two channels by providing two pencil beams that are orthogonally polarized in a 4-channel antenna. Reference numeral 502 denotes a dielectric substrate, 504 denotes a feeding unit, and 506 denotes a dipole antenna.

In order to implement two orthogonal polarizations, for example, a stereographic-crossed dipole radiation structure, such as that of FIG. 4, was used. A ground surface used as the ground of a dipole antenna functions as the parasitic radiation element of an annular-ring antenna, extends the operating bandwidth of the annular-ring antenna, and enables 50-ohm matching. A second-order higher-order mode TM21 shows a high-impedance tendency, but has low impedance by way of coupling between an antenna and a parasitic patch when the parasitic patch is placed on the upper side, thereby enabling 50-ohm matching.

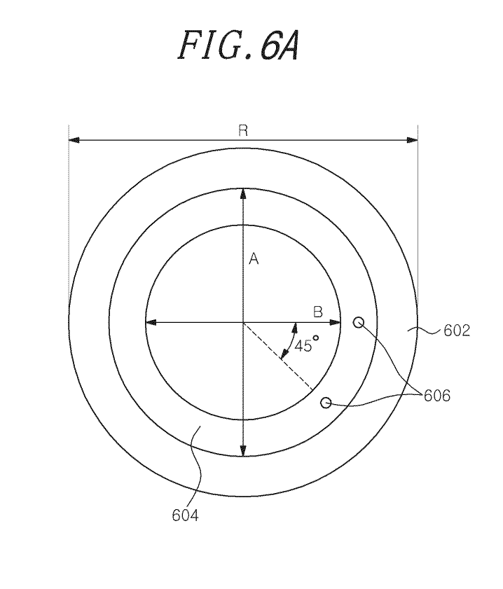

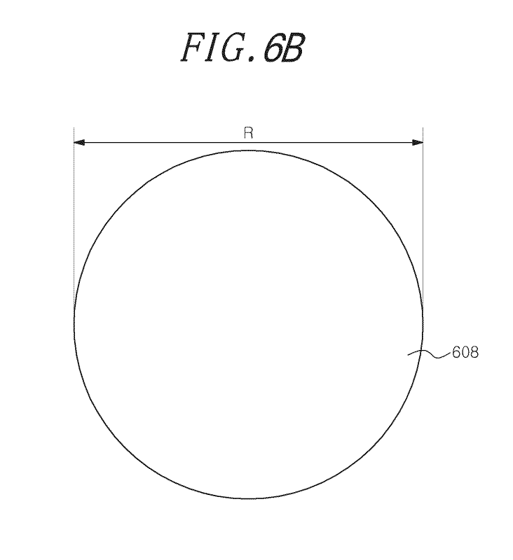

FIGS. 6a and 6b show the structure of an annular-ring antenna that forms two channels. The annular-ring antenna has been illustrated as forming two channels by providing two conical beams that are orthogonally polarized in a 4-channel antenna. Reference numeral 602 denotes a dielectric substrate, 604 denotes an annular-ring antenna, 606 denotes a feeding unit, and 608 denotes a parasitic patch. The two feeding units 606 are present in the annular-ring antenna 604, and each of the feeding units 606 has a 45-degree isolation distance. This isolation distance improves isolation between feeding units with a TM21 mode which form conical beams.

An Envelope Correlation Coefficient (ECC), that is, one of the performance indices of a MIMO antenna, is described below. The ECC is an index indicating a correlation between antennas. That is, the ECC indicates the amount of interference between antennas and dominates the performance of a MIMO antenna. In a MIMO antenna, better performance is obtained as an ECC has a smaller value. The reason why an ECC is important in a MIMO antenna is that the ECC influences a channel capacity. First, Equation 1 can be obtained using the radiation pattern of an antenna.

$$\text{?} \approx \frac{{\vert \begin{matrix}\int {\int }_{Ω} ( XPR \cdot \text{?} ( θ , φ ) \text{?} ( θ , φ ) \text{?} ( θ , φ ) + \\ \text{?} ( θ , φ ) \text{?} ( θ , φ ) \text{?} ( θ , φ ) ) d Ω\end{matrix} \vert}^{2}}{\begin{matrix}\int {\int }_{Ω} ( XPR \cdot \text{?} ( θ , φ ) \text{?} ( θ , φ ) + \\ \text{?} ( θ , φ ) \text{?} ( θ , φ ) ) d Ω \cdot \int {\int }_{Ω} ( XPR \cdot \text{?} ( θ , φ ) \text{?} ( θ , φ ) + \\ \text{?} ( θ , φ ) \text{?} ( θ , φ ) ) d Ω\end{matrix}} \\ Ω = \{ ( θ \cdot φ ) \text{:} 0 < θ < π , 0 < φ < 2 π \} \\ \text{?} ( θ , φ ) = {\vert {E}_{θ} ( θ , φ ) \vert}^{2} \\ \text{?} ( θ , φ ) = {\vert \text{?} ( θ , φ ) \vert}^{2} \\ XPR = \frac{{P}_{v}}{{P}_{H}} \\ \text{?} ( θ , φ ) = {A}_{θ} \text{?} , 0 \leq θ \leq π \\ \text{?} ( θ , φ ) = \text{?} \text{?} , 0 \leq θ \leq π \\ \text{?} \text{indicates text missing or illegible when filed} \qquad [ Equation 1 ]$$

In Equation 1, XPR is a ratio of vertical and horizontal polarizations, and P is a function indicating environments around the antenna.

If the antenna is in an isotropic environment, the function is defined so that XPR=1, mv, mh=0, and a standard deviation is infinite. There is an advantage in that environments around the antenna can be easily defined mathematically using the parameters of the function, and thus various environments can be created.

The method of Equation 1 is advantageous in that a precise ECC can be obtained, but is disadvantageous in that Equation 1 is slightly complicated because it is complicated in a calculation process and can be obtained only the radiation patterns of the antenna in all directions are known. In order to simplify this complexity, a process of extracting an ECC based on an S parameter can be realized as in Equation 2 below.

$$\text{?} \approx {\vert \text{?} \vert}^{2} = \frac{{\vert {S}_{11}^{*} {S}_{12} + {S}_{21}^{*} {S}_{22} \vert}^{2}}{( 1 - ( {\vert {S}_{11} \vert}^{2} + {\vert {S}_{21} \vert}^{2} ) ) \cdot ( 1 - ( {\vert {S}_{22} \vert}^{2} + {\vert {S}_{12} \vert}^{2} ) )} \\ \text{?} \text{indicates text missing or illegible when filed} \qquad [ Equation 2 ]$$

From Equation 2, it can be seen that a calculation process is simplified and an ECC can be easily calculated in all bands if the S parameter is used. In particular, it can be seen that an ECC becomes better as a reflection loss and isolation becomes better. There is almost no difference in the results of Equations 1 and 2.

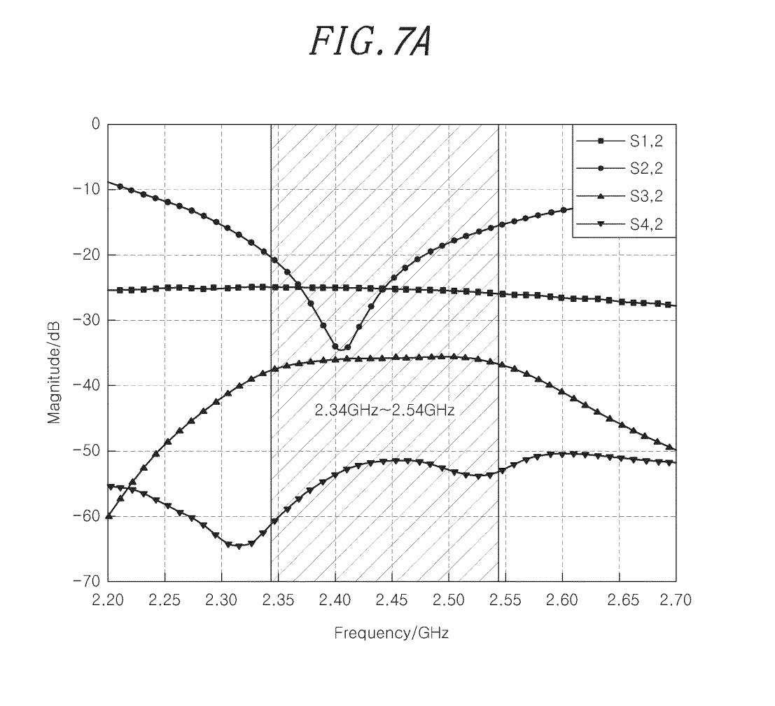

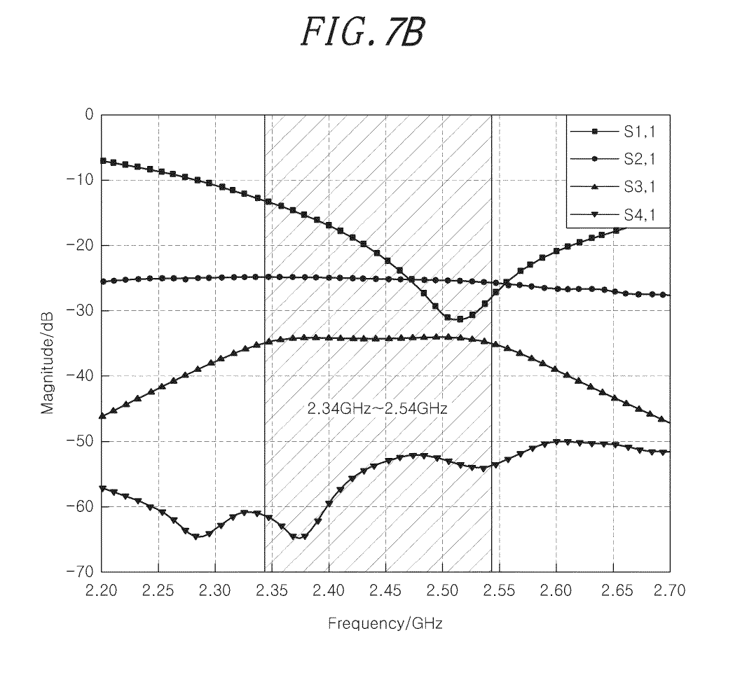

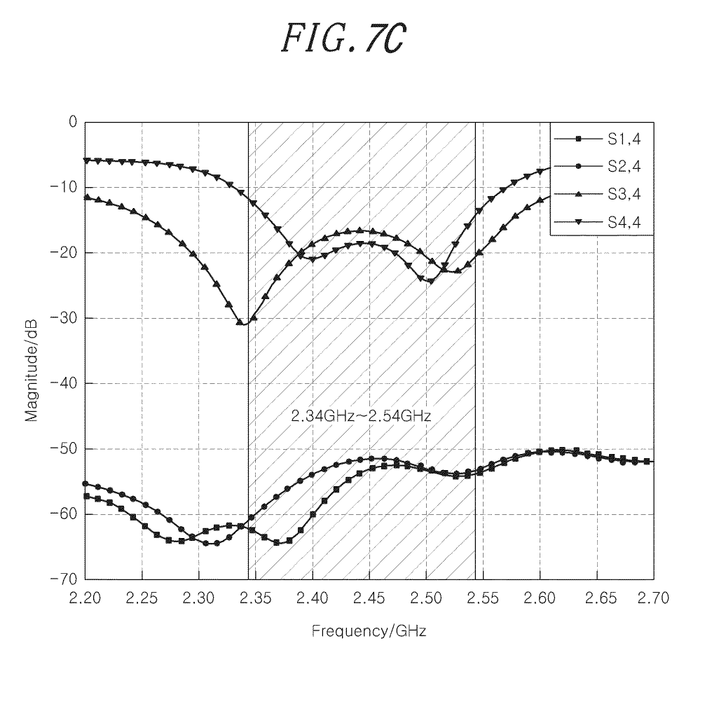

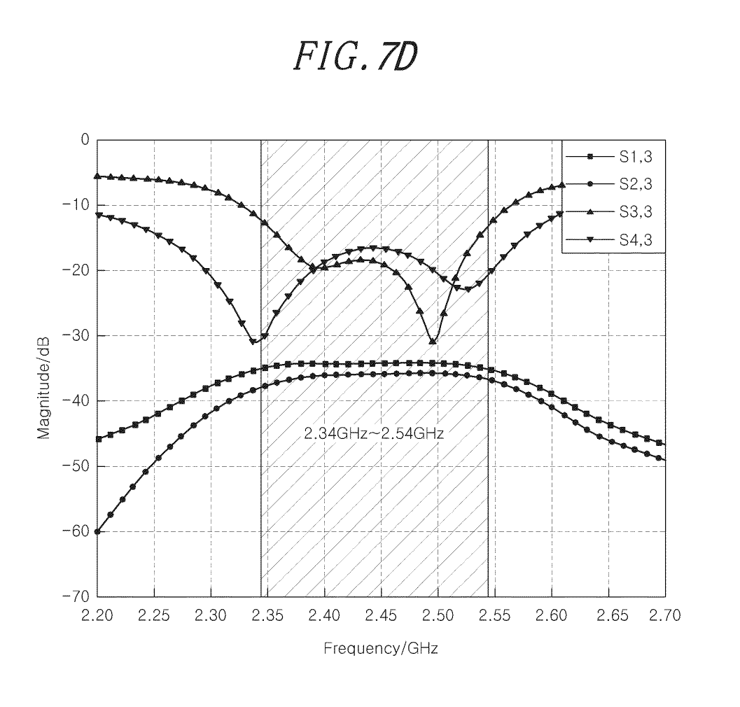

FIGS. 7a to 7d are graphs showing the reflection losses and isolation characteristics of four MIMO antennas.

FIG. 7 shows the reflection loss and isolation characteristics of an MIMO antenna, that is, the results of an embodiment of an antenna designed in a 2.45 GHz using an antenna shape, such as that of FIG. 4.

That is, the four MIMO antennas have excellent reflection losses of −10 dB or less in a 2.34 to 2.54 GHz and have isolation having a maximum of 16.5 dB in the operating band. Accordingly, it can be clearly seen that the MIMO antennas of FIG. 7 are suitably used as MIMO antennas because they operate independently without mutual coupling between the MIMO antennas.

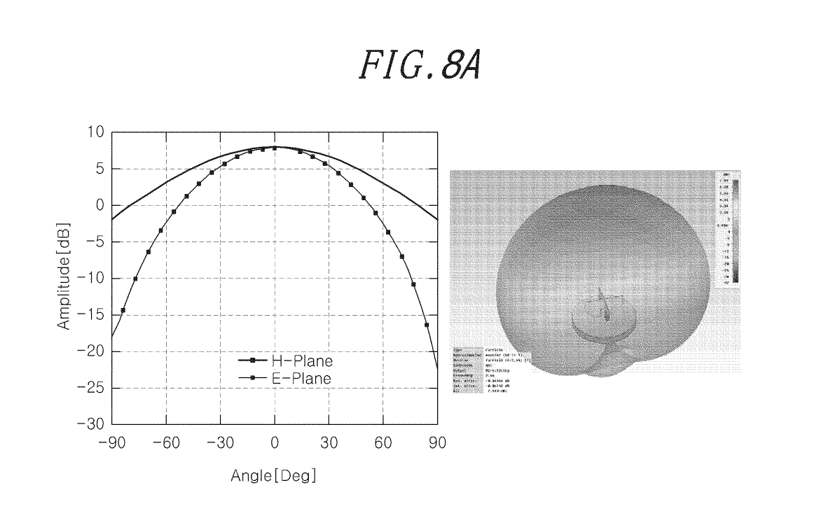

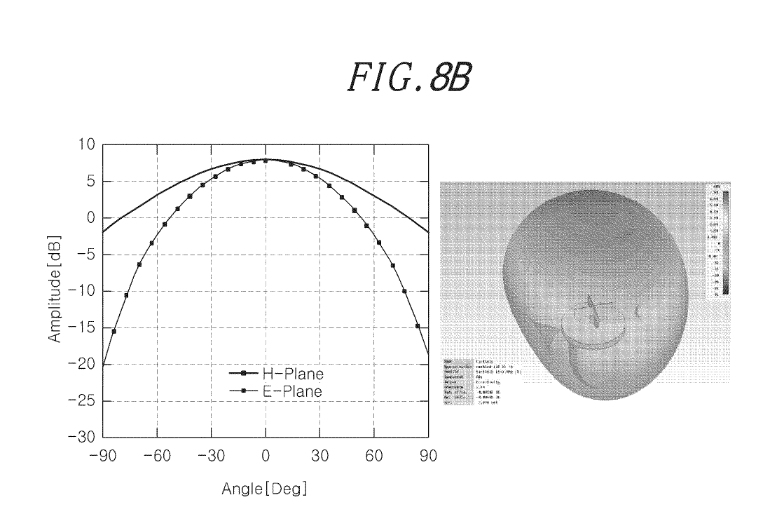

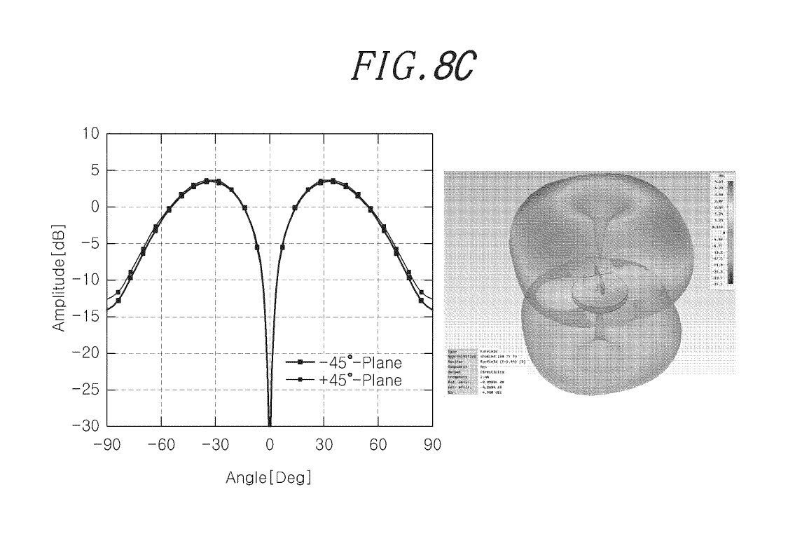

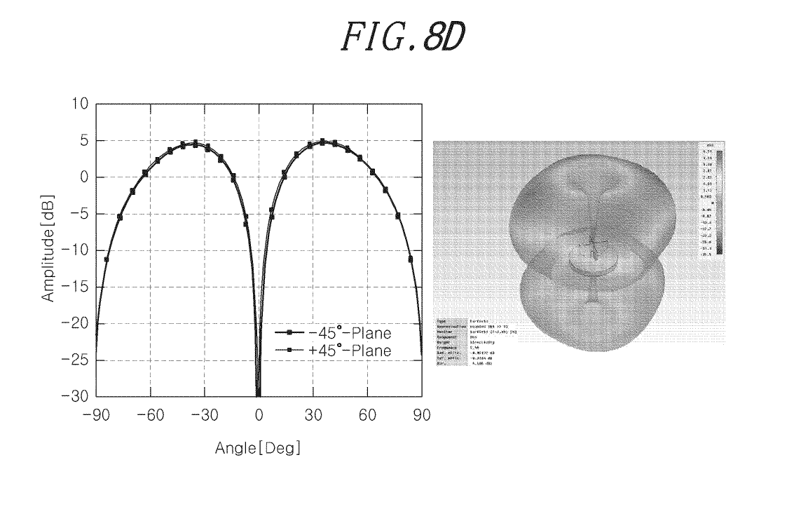

FIGS. 8a to 8d are graphs and beam patterns showing the radiation patterns of the four MIMO antennas.

From FIG. 8, it can be seen that the basic mode radiator (i.e., the antennas 1 and 2) forms a main beam pattern having two orthogonal linear polarizations of 7.6 dBi and has high antenna efficiency of 98% and the higher-order mode radiator (i.e., the antennas 3 and 4) forms a conical beam pattern having two orthogonal linear polarizations of 3.7 dBi and has high antenna efficiency of 92%.

Table 1 below show ECCs between antennas designed for experiments, which were checked down to three places of decimals using Equation 3. The ECCs below clearly reveal that the antennas are suitable for MIMO antennas.

TABLE 1

| Frequency | ECC between | ECC between | ECC between | ECC between | ECC between | ECC between |
|---|---|---|---|---|---|---|
| [GHz] | Ant1 and Ant2 | Ant1 and Ant3 | Ant1 and Ant4 | Ant2 and Ant3 | Ant2 and Ant4 | Ant3 and Ant4 |
| 2.34 | 0.001 | 0.000 | 0.001 | 0.000 | 0.000 | 0.002 |
| 2.44 | 0.000 | 0.000 | 0.000 | 0.000 | 0.000 | 0.000 |
| 2.54 | 0.000 | 0.000 | 0.000 | 0.000 | 0.000 | 0.001 |

If the antenna device in accordance with the present invention is used, a multi-function antenna which provides antenna beam pattern (or direction) diversity or orthogonal polarization diversity at the same time through a single antenna can be implemented by selecting and controlling antennas. This antenna device is suitable for the next-generation MIMO antenna that provides a high-scattering environment condition for high-speed data transmission because it can provide polarization and radiation pattern diversity at the same time. Accordingly, there is an advantage in that communication quality in a transmission and reception system can be improved if the antenna device is combined with a baseband signal processing unit.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A multi-channel antenna device, comprising:
a feeding circuitry; and
a basic mode radiator for forming a basic mode main beam pattern having one or two orthogonal polarizations based on first two orthogonal inputs received from the feeding circuitry; and
a higher-order mode radiator for forming a higher-order mode conical beam pattern having one or two orthogonal polarizations based on second two orthogonal inputs received from the feeding circuitry.

2. The multi-channel antenna device of claim 1, wherein the basic mode radiator and the higher-order mode radiator has a complex stack type radiator structure in which the basic mode radiator is formed over the higher-order mode radiator with a dielectric interposed between the basic mode radiator and the higher-order mode radiator.

3. The multi-channel antenna device of claim 2, wherein the dielectric is a plastic element.

4. The multi-channel antenna device of claim 1, wherein the basic mode radiator is a printed-cross dipole antenna.

5. The multi-channel antenna device of claim 1, wherein the basic mode radiator is a stereographic dipole antenna.

6. The multi-channel antenna device of claim 1, wherein the basic mode radiator is a single or stack microstrip antenna.

7. The multi-channel antenna device of claim 1, wherein the higher-order mode radiator is a single or stack annular-ring antenna.

8. The multi-channel antenna device of claim 1, wherein the higher-order mode radiator is a single or stack circular antenna.

9. The multi-channel antenna device of claim 1, wherein a portion of the higher-order mode radiator is used as a ground surface of the basic mode radiator.

10. The multi-channel antenna device of claim 9, wherein the portion is a stack parasitic element of the higher-order mode radiator.

11. The multi-channel antenna device of claim 10, wherein a short region is placed in a central part of the stack parasitic element.

12. The multi-channel antenna device of claim 9, wherein the ground surface comprises a conductor wall formed in a specific height along an outer circumferential surface of the ground surface.

13. The multi-channel antenna device of claim 12, wherein the conductor wall provides a backward radiation suppression function.

14. The multi-channel antenna device of claim 1, wherein a portion of the higher-order mode radiator is used as a reflector structure of the basic mode radiator.

15. The multi-channel antenna device of claim 14, wherein the portion is a stack parasitic element of the higher-order mode radiator.

16. The multi-channel antenna device of claim 1, wherein the feeding circuitry performs a 90-degree phase delay function and an input impedance matching function when a circular polarization is necessary.
